(19) United States
(12) Patent Application Publication
(10) Pub. No.: US 2006/0274239 A1
(43) Pub. Date: Dec. 7, 2006

(54) Liquid crystal display and method of manufacturing of a TFT array panel of the same

(76) Inventors: Young-Chol Yang, Seongnam-si (KR); Akira Hirai, Seongnam-si (KR)

Correspondence Address: CANTOR COLBURN, LLP, 55 GRIFFIN ROAD SOUTH, BLOOMFIELD, CT, 06002, US

(21) Appl. No.: 11/440,852

(22) Filed: May 25, 2006

(30) Foreign Application Priority Data
May 27, 2005 (KR) 10-2005-0045018

(51) Int. Cl. G02F 1/1335

(52) U.S. Cl. 349/114

(57) ABSTRACT

The present invention provides an LCD and method of manufacture of a TFT array panel of an LCD that efficiently utilizes all light emitted from a backlight unit to display images without light loss. In an exemplary embodiment, an LCD having a transmission area and a reflection area includes a first substrate, a reflection element formed on the first substrate corresponding to the reflection area, a TFT formed on the first substrate, a pixel electrode having a transparent electrode formed on the TFT and a reflective electrode that overlies the transparent electrode and is formed at the reflection area, a second substrate, an optical retardation layer formed on the second substrate causes a phase difference between light passing through the transmission area and the reflection area, and a common electrode formed on the optical retardation layer.

This application claims priority to Korean Patent Application No. 2005-0045018, filed on May 27, 2005, and all the benefits accruing therefrom under 35 U.S.C. §119, and the contents of which in its entirety are herein incorporated by reference.

### BACKGROUND OF THE INVENTION

(a) Field of the Invention

The present invention relates generally to a liquid crystal display (“LCD”), and method of manufacturing of a TFT array panel of LCD and more particularly, to a transflective LCD having transmission areas and reflection areas.

(b) Description of the Related Art

Generally, an LCD includes an upper panel having a common electrode and color filters, a lower panel having thin film transistors (“TFTs”) and pixel electrodes, and a liquid crystal (“LC”) layer interposed between the two panels. In an LCD, a voltage difference between the common electrode and the pixel electrodes generates an electric field in the LC layer, and the orientations of LC molecules in the LC layer are varied by the strength of the electric field. Since the transmittance of light passing through the LCD greatly depends upon the orientations of the LC molecules, a desired image display can be obtained by controlling the voltage difference between the common electrode and the pixel electrodes.

Depending on the light source used for image display, LCDs are divided into three types: transmissive, reflective and transflective. In a transmissive LCD, an image is displayed using light emitted from a backlight unit that is provided behind an LC panel assembly of the device. In a reflective LCD, an image is displayed by reflecting external natural light or external artificial light coming from the front of the device.

The transmissive LCD is disadvantageous under very bright external conditions, e.g., when light emitted from the backlight unit becomes significantly lower in brightness than external light so that visibility and display characteristics of the device suffer. In addition, the backlight unit of the transmissive LCD requires significant power. Meanwhile, the reflective LCD does not fully function as a display device when the external light is insufficient. Due to the above drawbacks of these LCDs, the transflective LCD, which combines transmissive and reflective characteristics, was developed. The transflective LCD operates in a transmissive mode under medium light conditions, such as in an indoor environment or under complete darkness. The transflective LCD operates in a reflective mode under very bright conditions, such as in an outdoor environment.

Generally, such a transflective LCD has transmission areas and reflection areas. Light emitted from the backlight unit that is provided behind the LC panel assembly passes through the transmission areas so that an image is displayed, whereas external light coming from the front of the device is reflected by internal reflective components in the reflection areas back to the front of the device so that an image is displayed.

However, the light emitted from the backlight unit is introduced to the reflection areas as well as to the transmission areas. The light entering the reflection areas is returned to the backlight unit again when it hits reflective electrodes. In this case, a circularly polarizing system, which is provided in the rear of the LCD assembly and consists of an optical retardation layer and a polarizer, removes the reflected light completely by absorption. Therefore, the light entering the reflection areas from the backlight unit is not utilized for the image display.

Even if the light from the backlight unit is not absorbed, the light may be scattered with the reflection at the reflective electrodes having uneven top surfaces, or it may disappear by failing to pass through an organic passivation layer with very low transmittance.

### BRIEF SUMMARY OF THE INVENTION

The present invention provides an LCD that efficiently utilizes all light emitted from a backlight unit to display images without light loss.

According to an exemplary embodiment of the present invention, an LCD with a transmission area and a reflection area includes a first substrate, a reflection element formed on the first substrate corresponding to the reflection area, a TFT formed on the first substrate, a pixel electrode having a transparent electrode formed on the TFT and a reflective electrode that overlies the transparent electrode and is formed at the reflection area, a second substrate, an optical retardation layer formed on the second substrate causes a phase difference between light passing through the transmission area and the reflection area, and a common electrode formed on the optical retardation layer.

The LCD may further include a storage electrode that overlaps the pixel electrode.

The TFT may include a gate electrode, a semiconductor formed on the gate electrode, and a source electrode and a drain electrode that are connected to the semiconductor.

The reflection element may be adjacent to the storage electrode, and may also be connected to the storage electrode or the drain electrode.

At least one outline portion defining the reflection element may be placed near a boundary of the reflection area and the transmission area.

The storage electrode and the reflection element may include Al, an Al alloy, Ag or an Ag alloy.

The LCD may further include a reflection assistant that is formed between the first substrate and the TFT and is placed at the reflection area.

The reflection assistant may include a dielectric with a multi-layered structure, and each layer in the multi-layered structure has a thickness that may satisfy nd=λ/4 where n is a refractive index of the layer, d is a thickness of the layer, and λ is a wavelength of light.

The dielectric of the reflection assistant may include at least a low refractive layer and a high refractive layer. The high refractive layer may include ZrO₂, TiO₂, or ZnS, while the low refractive layer may include MgF₂ or CeF₂.

The optical retardation layer may cause a phase difference of a quarter wavelength in light passing therethough in the reflection area, while causing no phase difference in the transmission area. The optical retardation layer may include an LC polymer. The LC polymer may be obtained by curing a UV-curable nematic LC monomer.

The LCD may further include a backlight unit that is disposed at the rear of the first substrate. The backlight unit may include a reflective plate.

The LC layer includes LC molecules that may be aligned in a twisted nematic mode.

The LCD may further include a passivation layer formed between the thin film transistor and the transparent electrode and having an opening that is placed at the transmission area.

The LCD may further include color filters that are formed between the optical retardation layer and the common electrode or between the second substrate and the optical retardation layer.

The color filters may exhibit different colors with each other and may have different thicknesses depending on the exhibiting colors.

A portion of each color filter corresponding to the transmission area may be formed thicker than the remaining portion of the same color filter corresponding to the reflection area.

The LCD may further include a first polarizer and a second polarizer that are individually attached to outer surfaces of the first substrate and the second substrate, respectively.

According to another exemplary embodiment of the present invention, a method of manufacturing a TFT array panel of an LCD is disclosed. The method includes alternately depositing two media having different indices of refraction on an insulating substrate forming a dielectric layer consisting of first and second alternating layers; removing the dielectric layer corresponding to transmission areas TA forming a plurality of reflection assistants 119 existing only at reflective areas RA; forming a first conductive layer on the substrate having the reflection assistants; selectively etching the conductive layer forming a plurality of gate lines with gate electrodes, a plurality of storage electrode lines with storage electrodes and a plurality of reflection assistants; depositing in succession a gate insulating layer, a hydrogenated amorphous silicon layer, and an amorphous silicon layer doped with N+ impurities on the conducting layer; patterning the hydrogenated amorphous silicon layer and the doped amorphous silicon layer forming a plurality of semiconductors with a plurality of projections and expansions, and forming a plurality of ohmic contact patterns; forming a second conductive layer made of a refractory metal including one of a Mo-containing metal, Ta, Cr or Ti, on a resultant of the patterning; selectively etching the second conductive layer forming a plurality of drain lines with source electrodes and end portions, and a plurality of drain electrodes with expansions; removing exposed portions of the ohmic contact patterns, which are not covered with the data lines and the drain electrodes, thereby forming a plurality of ohmic contacts, and the underlying semiconductors are exposed between the ohmic contacts; performing an O₂ plasma to stabilize the exposed surfaces of the semiconductors; depositing a lower passivation layer consisting of SiNx is deposited on the entire substrate; forming an upper passivation layer on the lower passivation layer; partially exposing the upper passivation layer to light through a mask, and then a developing process is performed, thereby forming a plurality of contact holes through which the lower passivation layer overlying the expansions of the drain electrodes is partially exposed; forming an uneven at a surface of the upper passivation layer; removing the upper passivation layer corresponding to the transmission areas TA forming a plurality of transmission windows; patterning the lower passivation layer by photolithography using a photoresist pattern to form the contact holes that penetrate the upper and lower passivation layers; forming a plurality of transparent electrodes connected to the drain electrode through the contact holes; and forming a plurality of reflective electrodes made of Ag or Al on the transparent electrodes.

### BRIEF DESCRIPTION OF THE DRAWINGS

The above objects and other advantages of the present invention will become more apparent by describing exemplary embodiments thereof in more detail with reference to the accompanying drawings.

FIG. 1 is a plan view layout of a first exemplary embodiment of an LCD according to the present invention.

FIG. 2 is a plan view layout of a second exemplary embodiment of an LCD according to the present invention.

FIG. 3 is a plan view layout of a third exemplary embodiment of an LCD according to the present invention.

FIG. 4 is a schematic cross-sectional view cut along line IV-IV of FIG. 1.

FIG. 5 is a schematic cross-sectional view cut along line V-V of FIG. 1.

FIG. 6 is a schematic view of the LCD shown in FIG. 1 for explaining the display principles thereof.

FIG. 7A through FIG. 7F are schematic cross-sectional views showing process steps to manufacture an exemplary embodiment of a TFT array panel of an LCD according to the present invention.

FIG. 8A through FIG. 8D are schematic cross-sectional views showing process steps to manufacture an exemplary embodiment of a color filter panel of an LCD according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

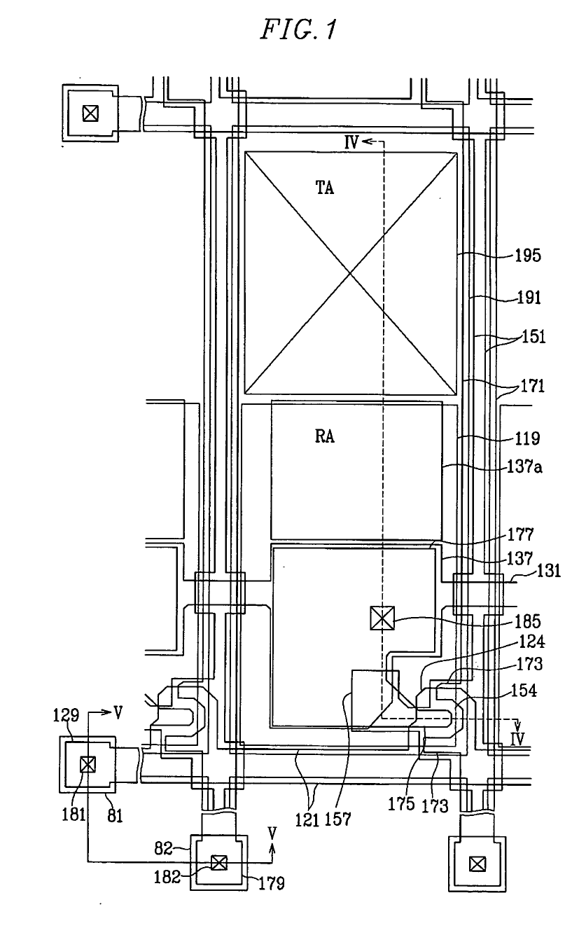

Hereinafter, exemplary embodiments of LCDs according to the present invention will be described in detail with reference to FIG. 1 through FIG. 5.

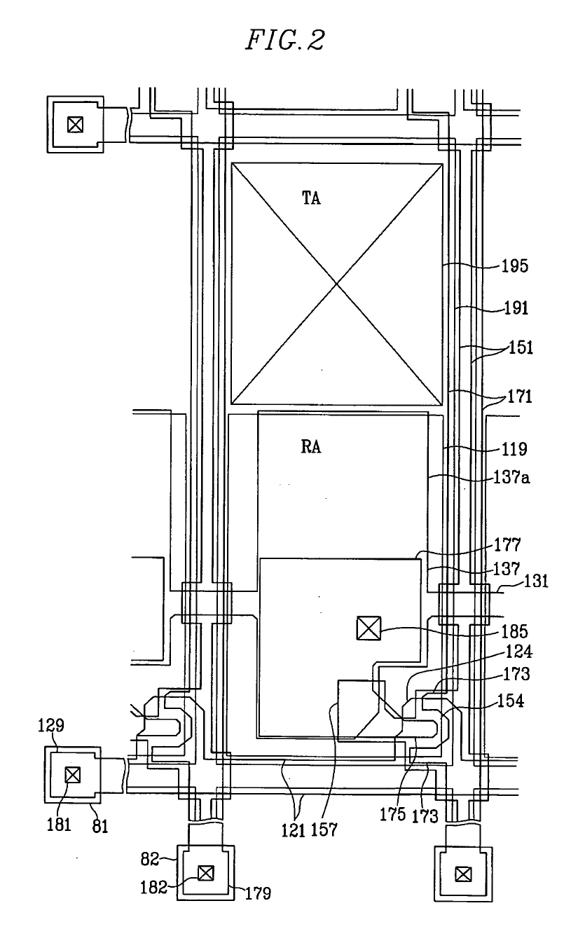

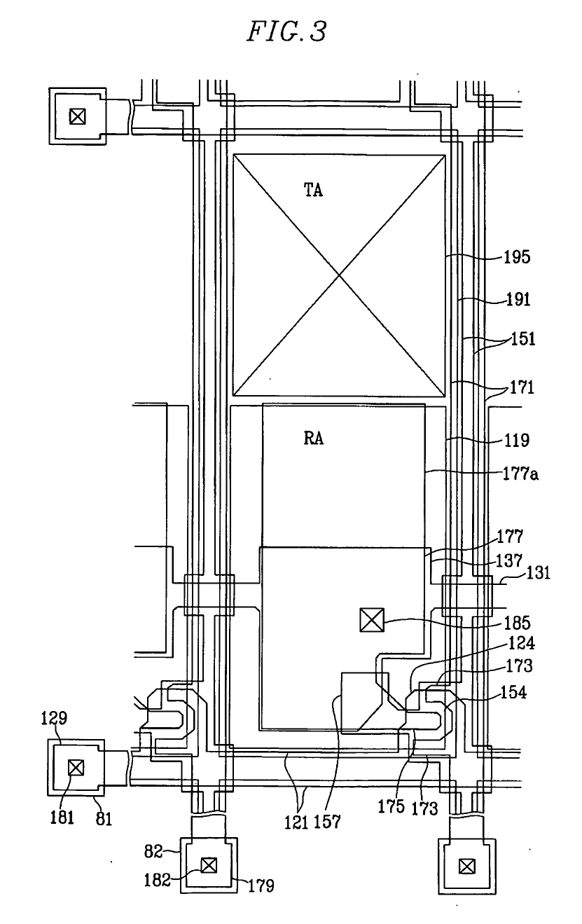

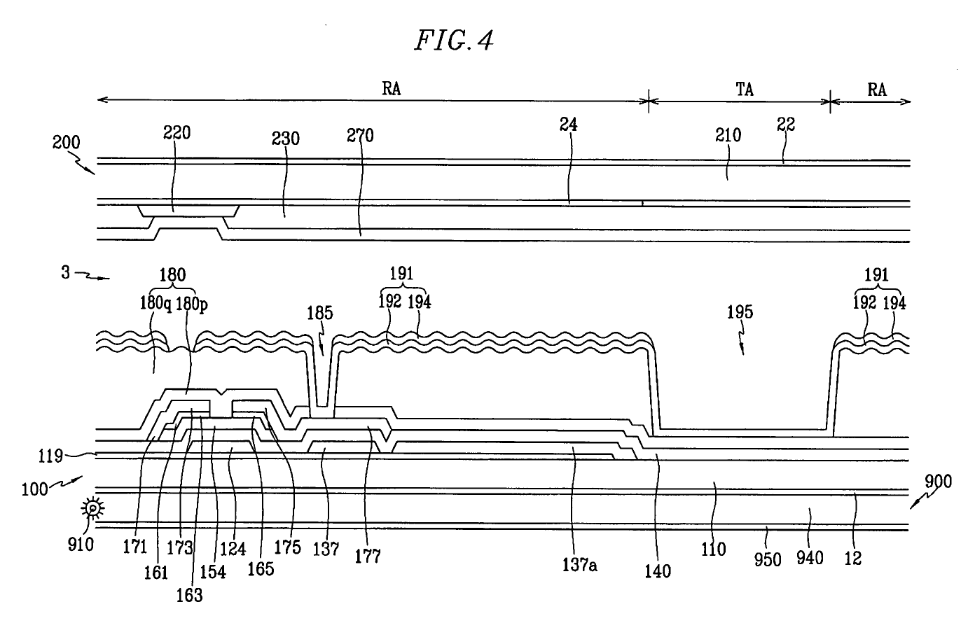

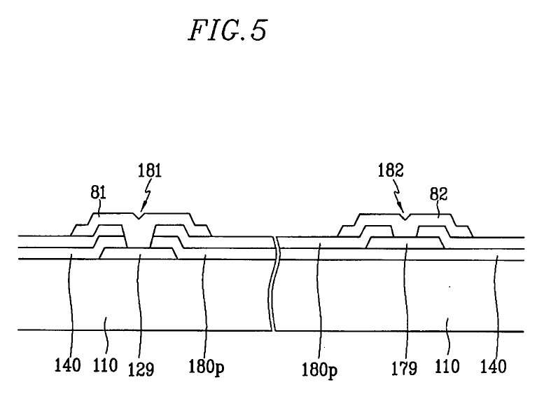

FIG. 1 is a plan view layout of a first exemplary embodiment of an LCD according to the present invention. FIG. 2 is a plan view layout of a second exemplary embodiment of an LCD according the present invention. FIG. 3 is a plan view layout of a third exemplary embodiment of an LCD according to the present invention. FIG. 4 and FIG. 5 are schematic cross-sectional views cut along lines IV-IV and V-V of FIG. 1, respectively.

Referring to FIG. 1 through FIG. 5, each of the exemplary embodiments of the LCDs according to the present invention include a TFT array panel 100 and a color filter panel 200 facing each other, and an LC layer 3 interposed therebetween with LC molecules that are aligned perpendicular or parallel to the surfaces of the two panels 100 and 200.

Referring to FIG. 4, a first polarizer 12 and a second polarizer 22 are individually attached to the outer surfaces of the two panels 100 and 200. Their transmission axes mutually cross each other at a right angle.

A backlight unit 900 is provided behind the TFT array panel 100. The backlight unit 900 includes lamps 910 (only one shown) for supplying artificial light to the LCD, a light guiding plate 940, and a light reflecting plate 950 that is disposed behind the light guiding plate 940.

In the present invention, cold cathode fluorescent lamps (“CCFLs”) or light emitting diodes (“LEDs”) are used for the lamps 910. However, other surface light sources or linear light sources may also be used.

The structure of the TFT array panel 100 is described first below.

A plurality of reflection assistants 119 are formed on an insulating substrate 110 made of transparent glass or plastic. The reflection assistants 119 may be made of a dielectric with a multi-layered structure, in which at least a high refractive layer and a low refractive layer are included. In such a structure, a thickness d of each layer is derived from nd=λ/4, where n is a refractive index of the layer and λ is a wavelength of light passing though the layer. The high refractive layer may be made of ZrO₂, TiO₂ or ZnS, and the low refractive layer may be made of MgF₂ or CeF₂.

A plurality of gate lines 121 and a plurality of storage electrode lines 131 are formed on the substrate 110 having the reflection assistants 119. In both exemplary embodiments shown in FIG. 1 and FIG. 2, a plurality of reflection elements 137a are formed on the respective reflection assistants 119. The reflection elements 137a reflect light supplied from the backlight unit 900.

The gate lines 121 for transmitting gate signals extend substantially in a horizontal direction as illustrated in FIGS. 1-3. Each gate line 121 includes a plurality of gate electrodes 124 protruding upward and an end portion 129 having a relatively large dimension to be connected to a different layer or an external device. Gate drivers (not shown) for generating the gate signals may be mounted on a flexible printed circuit (not shown) attached to the substrate 110, or directly on the substrate 110. Otherwise, the gate drivers may be integrated into the substrate 110. In this case, the gate lines 121 are directly connected to the gate drivers.

The storage electrode lines 131 that receive a predetermined voltage extend substantially parallel to the gate lines 121. Each storage electrode line 131 is placed between two adjacent gate lines 121; particularly, each storage electrode line 131 is placed closer to the lower-positioned gate line 121 of the two. Each storage electrode line 131 includes a plurality of storage electrodes 137 protruding upward and downward. Similar to the reflection elements 137a, the storage electrodes 137 reflect light supplied from the backlight unit 900. In the second embodiment shown in FIG. 2, the storage electrodes 137 are integrally formed with the respective reflection elements 137a. The form and arrangement of the storage electrode lines 131 discussed above are merely for illustrative purposes, and the storage electrode lines 131 may have other forms and arrangements.

The gate lines 121, the storage electrode lines 131 and the reflection elements 137a may be made of a good reflective metal such as an aluminum—(Al) containing metal such as Al or an Al alloy, or a silver—(Ag) containing metal such as Ag or a Ag alloy. They may also be made of a copper—(Cu) containing metal such as Cu or a Cu alloy, a molybdenum—(Mo) containing metal such as Mo and a Mo alloy, chrome (Cr), titanium (Ti) or tantalum (Ta). The gate lines 121, the storage electrode lines 131, and the reflection elements 137a may be configured as a multi-layered structure, in which at least two conductive layers (not shown) having different physical properties are included. In such a structure, one of the two conductive layers is made of a low resistivity metal, such as an Al-containing metal, a Ag-containing metal, a Cu-containing metal, or the like, in order to reduce delay of the signals or voltage drop in the gate lines 121, the storage electrode lines 131 and the reflection elements 137a. The other conductive layer is made of a material having prominent physical, chemical and electrical contact properties with other materials such as indium tin oxide (ITO) and indium zinc oxide (IZO). For example, a Mo-containing metal, Cr, Ta or Ti may be used to form the same layer. Desirable examples of the combination of the two layers are a lower Cr layer and an upper Al (or Al alloy) layer, and a lower Al (or Al alloy) layer and an upper Mo (or Mo alloy) layer. Besides the materials discussed above, various metals and conductors may be used to form the gate lines 121, the storage electrode lines 131 and the reflection elements 137a.

All lateral sides of the gate lines 121, the storage electrode lines 131, and the reflection elements 137a preferably have a slope of between about 30° and about 80° relative to the surface of the substrate 110.

A gate insulating layer 140 made of silicon nitride (SiNₓ) or silicon oxide (SiO₂) is formed on the gate lines 121, the storage electrode lines 131 and the reflection elements 137a.

A plurality of linear semiconductors 151 made of hydrogenated amorphous silicon (abbreviated as “a-Si”) or polysilicon are formed on the gate insulating layer 140. Each linear semiconductor 151 extends substantially in a vertical direction, and includes a plurality of projections 154, which are formed along the respective gate electrodes 124, and a plurality of expansions 157, which extend from the respective projections 154 with reference to FIG. 4. The linear semiconductors 151 are enlarged in the vicinities of the gate lines 121 and the storage electrode lines 131.

A plurality of linear ohmic contacts 161 and island-shaped ohmic contacts 165 are formed on the linear semiconductors 151. The ohmic contacts 161 and 165 may be made of N+ hydrogenated amorphous silicon that is highly doped with N-type impurities such as phosphorus (P), or silicide. The linear ohmic contacts 161 include a plurality of projections 163. A set of a projection 163 and an island-shaped ohmic contact 165 is placed on a projection 154 and an expansion 157 of a semiconductor 151.

All lateral sides of the semiconductors 151, 154 and 157 and the ohmic contacts 161, 163 and 165 have a slope of between about 30° and about 80° relative to the surface of the substrate 110.

A plurality of data lines 171 and a plurality of drain electrodes 175 are formed on the ohmic contacts 161, 163, and 165 and the gate insulating layer 140. In the third exemplary embodiment shown in FIG. 3, a plurality of reflection elements 177a, which reflect light supplied from the backlight unit 900, are further formed on the gate insulating layer 140.

The data lines 171 for transmitting data signals extend substantially in a vertical direction to cross the gate lines 121 and the storage electrode lines 131 as illustrated in FIGS. 1-3. Each data line 171 includes a plurality of source electrodes 173 extending toward the respective gate electrodes 124, and an end portion 179 having a relatively large dimension to be connected to a different layer or an external device. Data drivers (not shown) for generating the data signals may be mounted on a flexible printed circuit (not shown) attached to the substrate 110, or directly on the substrate 110. Otherwise, the data drivers may be integrated into the substrate 110, in which case the data lines 171 are directly connected to the data drivers.

The drain electrodes 175 separated from the data lines 171 are placed opposite to the source electrodes 173, centering on the gate electrodes 124. Each drain electrode 175 includes an expansion 177 having a relatively large dimension and a bar-shaped end portion. The expansions 177 of the drain electrodes 175 overlap the storage electrodes 137 of the storage electrode lines 131 (see FIG. 4), and the bar-shaped end portions are partially surrounded with the source electrodes 173 curved in the shape of the character “J”. In the third exemplary embodiment shown in FIG. 3, the expansions 177 are integrally formed with the reflection elements 177a.

A gate electrode 124, a source electrode 173, a drain electrode 175 and a projection 154 of the semiconductor 151 form a thin film transistor (TFT). A TFT channel is formed in the projection 154 provided between the source electrode 173 and the drain electrode 175.

The data lines 171 and the drain electrodes 175 are preferably made of a refractory metal such as Mo, Cr, Ta or Ti, or any of their alloys, and may be configured as multi-layered structures including at least a refractory metal layer (not shown) and a low resistivity conductive layer (not shown). A desirable example of the multi-layered structure is a lower layer made of Cr, Mo or a Mo alloy and an upper layer made of Al or an Al alloy. Another example is a lower layer made of Mo or a Mo alloy, an intermediate layer made of Al or an Al alloy and an upper layer made of Mo or a Mo alloy. Besides the materials listed above, various metals and conductors can be used to form the data lines 171 and the drain electrodes 175.

All lateral sides of the data lines 171 and the drain electrodes 175 preferably have a slope of between about 30° and about 80° relative to the surface of the substrate 110.

The ohmic contacts 161, 163 and 165 exist only between the underlying semiconductors 151 and the overlying data lines 171 and between the overlying drain electrodes 175 and the underlying semiconductors 151, in order to reduce contact resistance therebetween. Most of the linear semiconductors 151 are formed more narrowly than the data lines 171, but partial portions of the linear semiconductors 151 are enlarged in the vicinities where they cross the gate lines 121, as previously mentioned, in order to prevent the data lines 171 from being shorted. The linear semiconductors 151 are partially exposed at places where the data lines 171 and the drain electrodes 175 do not cover them, as well as between the source electrodes 173 and the drain electrodes 175.

A passivation layer 180 is formed on the data lines 171, the drain electrodes 175 and the exposed portions of the semiconductors 151. The passivation layer 180 is configured as a double-layered structure including a lower layer 180p made of an inorganic insulator such as SiNₓ or SiO₂ and an upper layer 180q made of an organic insulator. A desirable organic insulator for the upper passivation layer 180q has a low dielectric constant of below 4.0 and/or photosensitivity. The upper passivation layer 180q is provided with apertures where the lower passivation layer 180p is partially exposed, and the top surface of the upper passivation layer 180q is uneven. The passivation layer 180 may be configured as a single layer made of an inorganic insulator or an organic insulator.

The passivation layer 180 is provided with a plurality of contact holes 182 and 185, through which the end portions 179 of the data lines 171 and the drain electrodes 175 are exposed, respectively. A plurality of contact holes 181 are formed in the passivation layer 180 and the gate insulating layer 140, and the end portions 129 of the gate lines 121 are exposed through the contact holes 181.

A plurality of pixel electrodes 191 and a plurality of contact assistants 81 and 82 are formed on the passivation layer 180.

Each pixel electrode 191 has a ripple-shaped profile caused by the uneven top surface of the upper passivation layer 180q. Each pixel electrode 191 has a transparent electrode 192 and a reflective electrode 194 overlying the transparent electrode 192. The transparent electrodes 192 are made of a transparent conductor such as ITO or IZO, and the reflective electrodes 194 are made of an opaque reflectivity conductor such as Al, Cr, Ag, or any of their alloys. The reflective electrodes 194 may be configured as a double-layered structure. In the double-layered structure, upper layers are made of a low resistivity metal such as Al, an Al alloy, Ag, or a Ag alloy, and lower layers are made of a material such as a Mo-containing metal, Cr, Ta, or Ti, which has prominent contact properties with ITO and IZO.

Each reflective electrode 194 exists only on a partial portion of the transparent electrode 192 and has a transmission window 195 that is aligned with one of the apertures of the upper passivation layer 180q. The transparent electrodes 192 are partially exposed through the transmission windows 195 of the reflective electrodes 194.

The pixel electrodes 191 are physically and electrically connected to the drain electrodes 175 through the contact holes 185 in order to receive data voltages from the drain electrodes 175. The pixel electrodes 191 supplied with the data voltages generate electric fields in cooperation with a common electrode 270 of the color filter panel 200, determining the orientations of the LC molecules in the LC layer 3 interposed between the two electrodes 191 and 270. According to the orientations of the LC molecules, the polarization state of light passing through the LC layer 3 is varied. Each set of a corresponding pixel electrode 191 and the common electrode 270 forms an LC capacitor that is capable of storing the applied voltage after the TFT is turned off.

A transflective LCD including the TFT array panel 100, the color filter panel 200 and the LC layer 3 is divided into a transmission area TA which is a section disposed on and under the transmission window 195 and a reflection area RA which is a section disposed on and under the reflective electrode 194. In the transmission area TA, light emitted from the backlight unit 900 passes through the TFT array panel 100 and the LC layer 3 and then exits the color filter panel 200, thus contributing to light for the display. In the reflection area RA, exterior light supplied through the front of the LCD passes through the color filter panel 200 and the LC layer 3 and is then reflected by the reflective electrodes 194 of the TFT array panel 100. The reflected light passes through the LC layer 3 again and then exits the color filter panel 200, thus contributing to light for the display. In these processes, the uneven top surfaces of the reflective electrodes 194 enhance the efficiency of reflection of light.

As shown in FIG. 4, the upper passivation layer 180q does not exist in the transmission area TA. Accordingly, a cell gap (i.e., a thickness of the LC layer 3) of the transmission area TA becomes nearly twice as large as that of the reflection area RA.

Referring to FIG. 1 to FIG. 3, each of the reflection elements 137a and 177a is placed in the reflection area RA, and is formed up to the vicinity of a boundary of the reflection area RA and the transmission area TA. These reflection elements 137a and 177a reflect light, which enters the reflection areas RA from the backlight unit 900, to the transmission areas TA, with the storage electrodes 137 and the expansions 177 of the drain electrodes 175. That is, the light entering the reflection areas RA from the backlight unit 900 is introduced to the transmission areas TA with the reflection at the storage electrodes 137 and the reflection elements 137a and 177a, thereby being used to display images. Each reflection assistant 119, which exists at the entire portion of the reflection area RA, increases reflection of the reflection elements 137a and 177a and the storage electrodes 137.

The structure of the color filter panel 200 facing the TFT array panel 100 is described below.

Referring to FIG. 4, an optical retardation layer 24 is formed on an insulating substrate 210 made of transparent glass or plastic. The optical retardation layer 24 generates phase differences between light rays passing through the reflection areas RA and the transmission areas TA. That is, the polarization state of light passing through the optical retardation layer 24 is not changed in the transmission areas TA, while it is changed in the reflection areas RA. More specifically, in the reflection areas RA, the optical retardation later 24 converts circularly polarized light into linearly polarized light or linearly polarized light into circularly polarized light by causing a phase difference of a quarter wavelength between two polarized components that are orthogonal to each other and are individually parallel to a fast axis and a slow axis of the optical retardation layer 24. The optical retardation layer 24 may be made of an LC polymer. The LC polymer is achieved by curing a UV-curing nematic LC monomer.

The LCD of the present invention utilizes only one optical retardation layer 24. This is possible because the single optical retardation layer 24 has different phase retardation values in the reflection areas RA and the transmission areas TA. Light entering the reflection area RA from backlight 910 is prevented from being absorbed by the first polarizer 12.

A light-blocking member 220 called a “black matrix” is provided on the optical retardation layer 24. The light-blocking member 220 prevents light from leaking out through barriers between the pixel electrodes 191 and delimits aperture regions facing the pixel electrodes 191.

A plurality of color filters 230 are formed on the substrate 210, the optical retardation layer 24 and the light-blocking member 220, and most of the color filters 230 are placed within the aperture regions delimited by the light-blocking member 220. The color filters 230 extend along the respective pixel electrodes 191, and are connected to one another as stripes. Each color filter 230 exhibits one of three colors such as red, green and blue colors, and may also be primary colors.

In the transflective LCD, since light passes through the color filters 230 only once in the transmission areas TA, while it passes twice in the reflection areas RA, a difference of color tone between the transmission areas TA and the reflection areas RA is generated. To reduce the difference of color tone between the two areas TA and RA, two methods can be used. The first method is to form a different thickness of each color filter 230 depending on its location. That is, in this method, a specific portion of the color filter 230, which is placed at the transmission area TA, is formed thicker than the remaining portion, which is placed at the reflection area RA. The second method is to form light holes in the reflection areas RA of the color filters 230 with the same thickness.

The color filters 230 may be formed under the optical retardation layer 24. In this case, the color filters 230 may be formed with a different thickness depending on the colors, and the optical retardation layer 24 overlying such color filters 230 may also be formed with a different thickness so that light passing through each color filter 230 has a phase difference of a quarter wavelength.

A common electrode 270 is formed on the light-blocking member 220 and the color filters 230. The common electrode 270 is preferably made of a transparent conductor such as ITO or IZO.

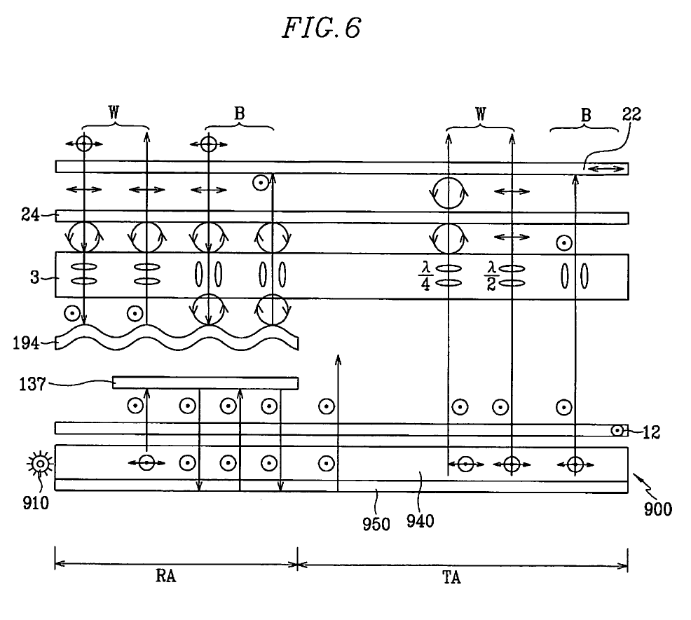

Hereinafter, the display principles of the above-mentioned LCDs will be described in detail with reference to FIG. 6.

FIG. 6 is a vertical scheme of the LCD shown in FIG. 1. FIG. 6 shows only components that are necessary to explain the display principles of the LCD. The following description is given on the assumption that the LC molecules in the LC layer 3 are aligned in a twist nematic (“TN”) mode, the first polarizer 12 transmits only light vibrating in the Y direction (⊙) which is vertical to ground, and the second polarizer 22 transmits only light vibrating in the X direction (⇄) which is parallel to ground. Generally, the TN LC molecules have peculiar optical properties. In detail, the TN LC molecules are aligned in a vertical direction when an electric field is applied, thereby causing no change in the polarization state of light passing through the LC layer 3, but are aligned in a horizontal direction when no electric field is applied, thereby changing the polarization state of light passing through the LC layer 3.

First, the display principles of light supplied from the ambient environment are described below.

Variations of the polarization states of light that enters the reflection areas RA of the LCD from the ambient environment when no electric field is applied to the LC layer 3 are first described below.

As shown in FIG. 6, external light is first incident onto the second polarizer 22. At this time, the second polarizer 22 transmits only linearly polarized light in the X direction of the incident light. Then, the linearly polarized light travels through the optical retardation layer 24, thereby being converted to left-hand circularly polarized light. Next, the left-hand circularly polarized light enters the LC layer 3. At this time, the LC layer 3 converts the left-hand circularly polarized light to linearly polarized light in the Y direction. Then, the linearly polarized light is reflected by the reflective electrodes 194, thereby entering the LC layer 3 again. At this time, the LC layer 3 converts the linearly polarized light into left-hand circularly polarized light. Subsequently, the left-hand circularly polarized light passes through the optical retardation layer 24. At this time, the left-hand circularly polarized light is converted to linearly polarized light in the X direction. Next, the linearly polarized light exits the LCD after passing through the second polarizer 22. At this time, an LCD screen is shown as a white state (W).

Next, variations of the polarization states of light that enters the reflection areas RA of the LCD from the ambient environment when an electric field is applied to the LC layer 3 are described below.

External light is first incident to the second polarizer 22. At this time, the second polarizer 22 transmits only linearly polarized light in the X direction of the incident light. Then, the linearly polarized light travels through the optical retardation layer 24, thereby being converted to left-hand circularly polarized light. Next, the left-hand circularly polarized light passes through the LC layer 3 without a change of the polarization state. Sequentially, the left-hand circularly polarized light is converted into right-hand circularly polarized light with the reflection at the reflective electrodes 194. The right-hand circularly polarized light passes through the LC layer 3 again without a change of the polarization state, and then enters the optical retardation layer 24. At this times the light is converted to linearly polarized light in the Y direction by the optical retardation layer 24. Next, the second polarizer 22 completely absorbs linearly polarized light in the Y direction, so that no light exits the LCD. In this case, the LCD screen is shown as a black state (B).

Next, the display principles of light supplied from the backlight unit 900 are described below.

Light, which enters the reflection areas RA of the LCD from the backlight unit 900, is first incident to the first polarizer 12. At this time, the first polarizer 12 transmits only linearly polarized light in the Y direction of the incident light. The linearly polarized light is reflected by the reflection elements 137a or 177a or the storage electrodes 137, which are formed on the substrate 110 of the TFT array panel 100, thereby being returned to the backlight unit 900 again without a change of the polarization state. The reflected light is returned back again when impacting the reflective plate 950 of the backlight unit 900, thereby entering the transmission areas TA. In this way, the light entering the reflection areas RA from the backlight unit 900 is finally introduced to the transmission areas TA, thereby being used to display an image. In these sequential processes, the reflection elements 137a and 177a, which extend up to the outlines or at least one outline portion defining the reflection areas RA, change a proceeding path of incident light backward by reflection in order to not meet the upper passivation layer 180q that is made of an organic material that is capable of absorbing light, thereby increasing utilization efficiency of the light that is supplied to the reflection areas RA of the LCD from the backlight unit 900.

Variations of the polarization states of light that enters the transmission areas TA from the backlight unit 900 when no electric field is applied to the LC layer 3 are described below.

The light emitted from the backlight unit 900 is first incident onto the first polarizer 12. At this time, the first polarizer 12 transmits only linearly polarized light in the Y direction of the incident light. Then, the linearly polarized light enters the LC layer 3. In the case that the LC layer 3 causes a phase difference of λ/2 in the light passing therethrough in the absence of the electric field, the light that is linearly polarized in the Y direction is converted to linearly polarized light in the X direction after passing through the LC layer 3, and then the converted light successively passes through the optical retardation layer 24 and the second polarizer 22 without a change of the polarization state. In this case, the LCD screen is shown as a white state (W). Whereas, in the case that the LC layer 3 causes a phase difference of λ/4 in the light passing therethrough in the absence of the electric field, the light that is linearly polarized in the Y direction is converted to left-hand circularly polarized light after passing through the LC layer 3. Then, the left-hand circularly polarized light enters the optical retardation layer 24. Next, the linearly polarized light passes through the second polarizer 22. In this case, the LCD screen is shown as a white state (W).

Variations of the polarization states of light that enters the transmission areas TA from the backlight unit 900 when an electric field is applied to the LC layer 3 are described below.

The light emitted from the backlight unit 900 is first incident onto the first polarizer 12. At this time, the first polarizer 12 transmits only linearly polarized light in the Y direction of the incident light. Then, the linearly polarized light enters the LC layer 3. In this case, since the LC molecules in the LC layer 3 with the electric field are aligned perpendicular to the surfaces of the panels 100 and 200, the light passes through the LC layer 3 without a change of the polarization state. Next, the linearly polarized light passes through the optical retardation layer 24 and is then absorbed by the second polarizer 22. In this case, the LCD screen is shown as a black state (B).

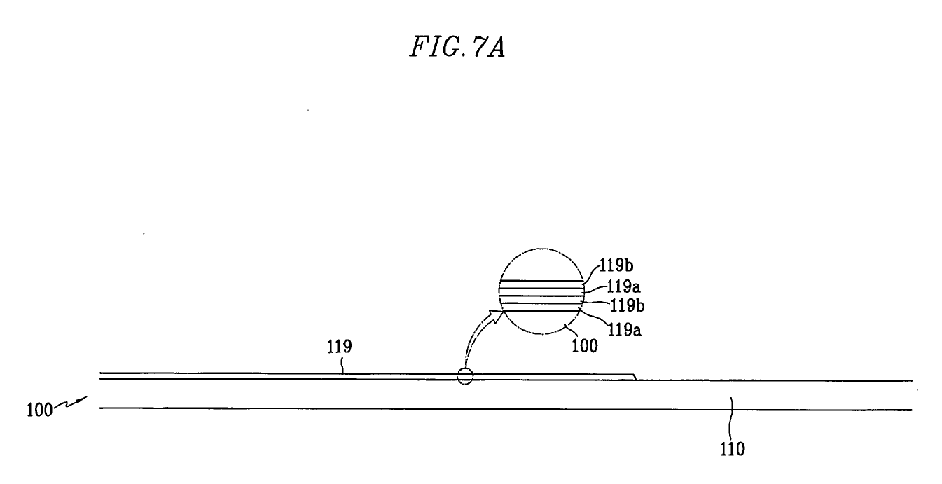

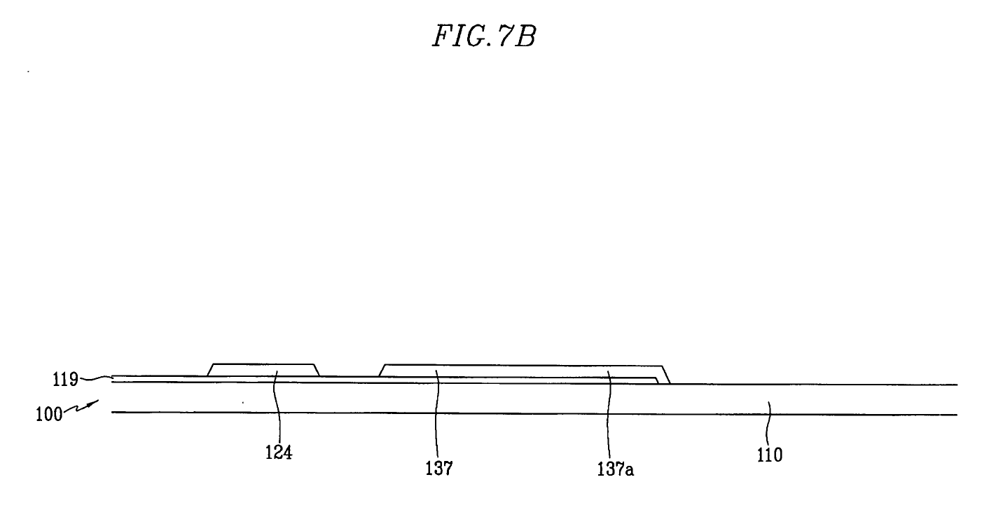

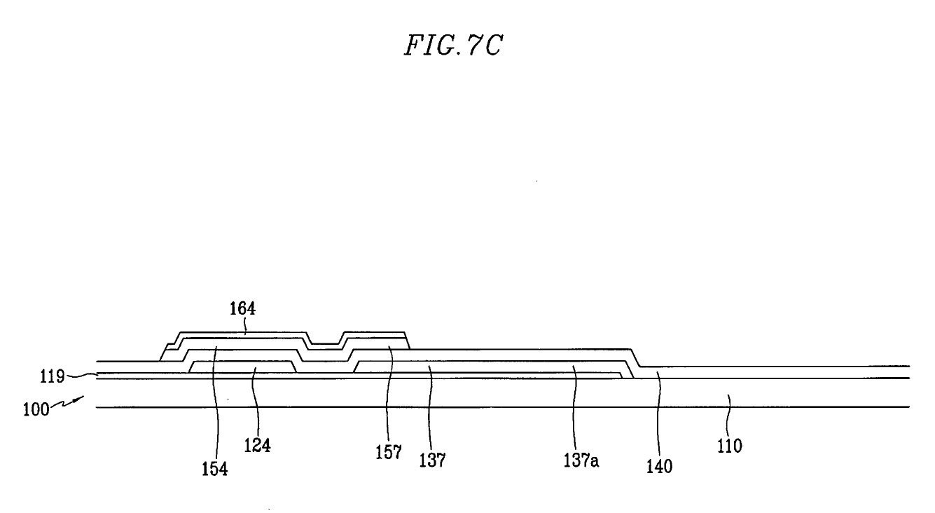

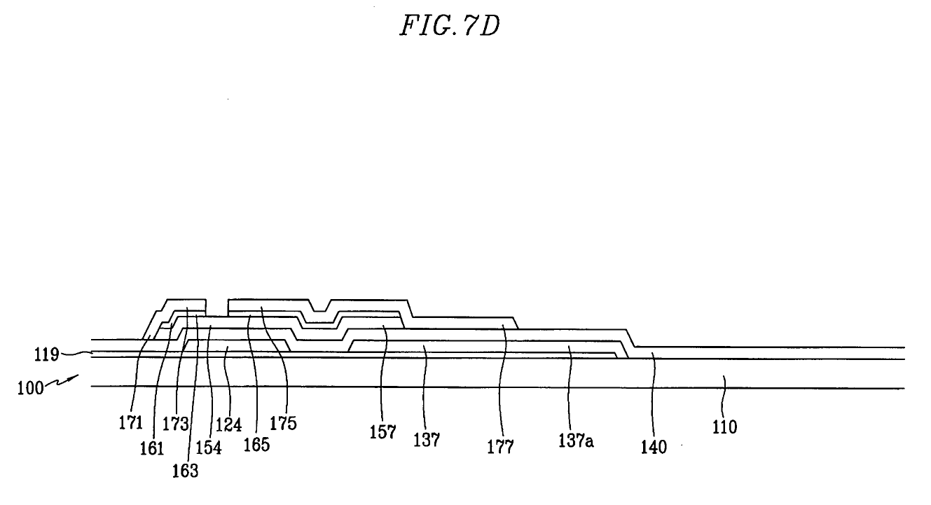

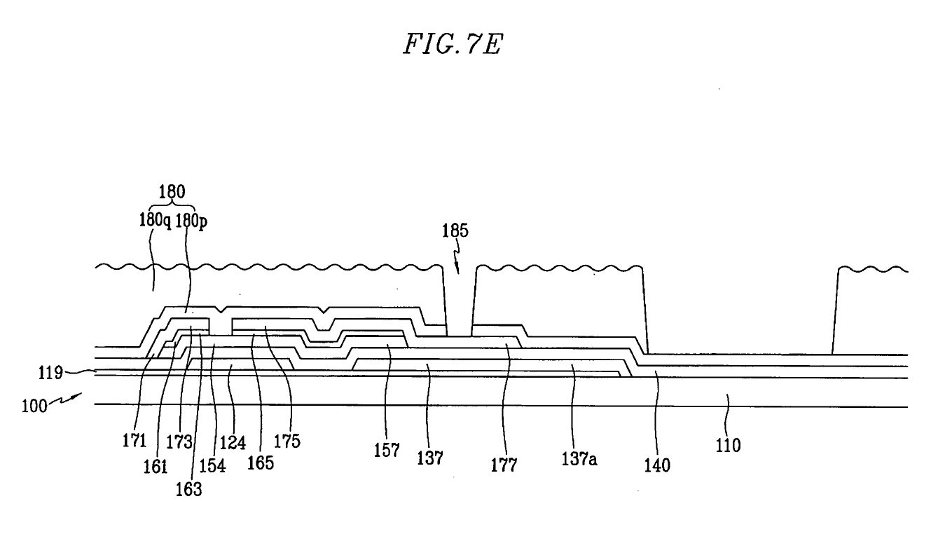

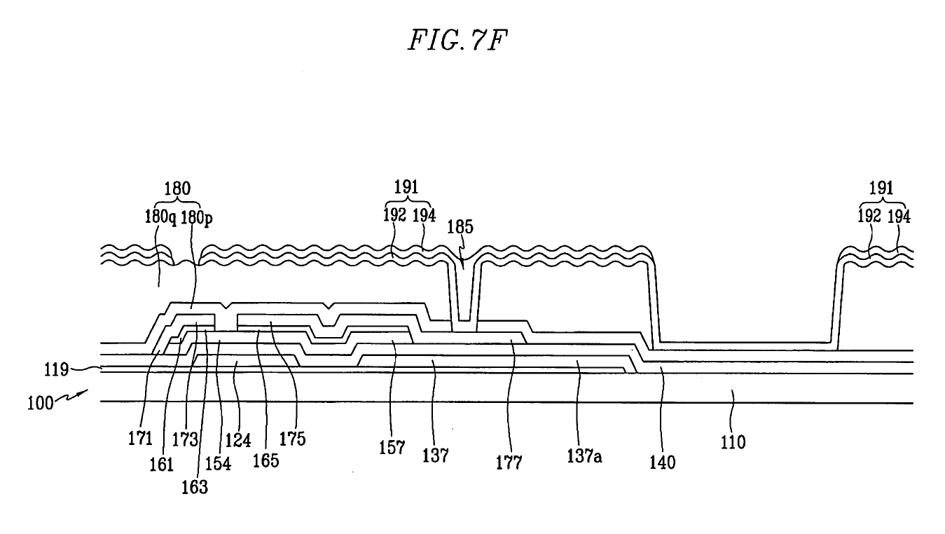

Hereinafter, a method of manufacturing a TFT array panel 100 of an LCD according to an exemplary embodiment of the present invention will be described with reference to FIG. 7A through FIG. 7E.

FIG. 7A through FIG. 7E are schematic cross-sectional views showing an exemplary embodiment of a method to manufacture a TFT array panel 100 of an LCD according to the present invention.

First, two media having different indices of refraction are alternately deposited on an insulating substrate 110 by a sputtering process, thereby forming a dielectric layer that consists of alternating layers 119a and 119b. Next, the dielectric layer corresponding to the transmission areas TA is removed by photolithography, thereby forming a plurality of reflection assistants 119 existing only at the reflective areas RA, as shown in FIG. 7A.

Next, a conductive layer is formed on the substrate 110 having the reflection assistants 119 by a sputtering process. This conductive layer may be made of an Al-containing metal such as Al or an Al alloy, a Ag-containing metal such as Ag or a Ag alloy, a Cu-containing metal such as Cu or a Cu alloy, a Mo-containing metal such as Mo or a Mo alloy, Cr, Ti or Ta.

The conductive layer is then selectively etched by photolithography, thereby forming a plurality of gate lines 121 with gate electrodes 124, a plurality of storage electrode lines 131 with storage electrodes 137, and a plurality of reflection assistants 137a, as shown in FIG. 7B. In FIG. 7B, the reflection assistant 137a is integrally formed with the storage electrode line 131. Differing from FIG. 7B, however, the reflection assistants 137a may be separated from the storage electrode lines 131 in alternative exemplary embodiments.

Subsequently, a gate insulating layer 140, a hydrogenated amorphous silicon layer, and an amorphous silicon layer doped with N⁺ impurities are successively deposited on the resultant of FIG. 7B by low pressure chemical vapor deposition (“LPCVD”) or plasma enhanced chemical vapor deposition (“PECVD”). The hydrogenated amorphous silicon layer and the doped amorphous silicon layer are then patterned, so that a plurality of semiconductors 151 with a plurality of projections 154 and expansions 157, and a plurality of ohmic contact patterns 164 are formed, as shown in FIG. 7C. The gate insulating layer 140 may be made of SiNₓ.

Next, a conductive layer made of a refractory metal such as a Mo-containing metal, Ta, Cr or Ti, is formed on the resultant of FIG. 7C by a sputtering process. The conductive layer is then selectively etched by photolithography, thereby forming a plurality of drain lines 171 with source electrodes 173 and end portions 179 (FIGS. 1-3), and a plurality of drain electrodes 175 with expansions 177, as shown in FIG. 7D. A plurality of reflection assistants 177a of the third exemplary embodiment of FIG. 3 may be further formed at this point. Each reflection assistant 177a is formed in the reflection area RA and is formed up to a boundary of the reflection area RA and the transmission area TA.

Subsequently, the exposed portions of the ohmic contact patterns 164, which are not covered with the data lines 171 and the drain electrodes 175, are removed. As a result, a plurality of ohmic contacts 163 and 165 are formed as shown in FIG. 7D, and the underlying semiconductors 154 are exposed between the ohmic contacts 163 and 165. Next, an O₂ plasma process is preferably performed to stabilize the exposed surfaces of the semiconductors 154.

Next, as shown in FIG. 7E, a lower passivation layer 180p consisting of SiNₓ is deposited on the entire substrate 110 by a CVD process. Then, an upper passivation layer 180q consisting of an organic material is formed on the lower passivation layer 180p. The upper passivation layer 180q is partially exposed to light through a mask, and then a developing process is performed, thereby forming a plurality of contact holes 185 through which the lower passivation layer 180p overlying the expansions 177 of the drain electrodes 175 is partially exposed. Next, an uneven pattern is formed at the surface of the upper passivation layer 180q, and the upper passivation layer 180q corresponding to the transmission areas TA is removed, thereby forming a plurality of transmission windows 195 (FIGS. 1-3).

Next, the lower passivation layer 180p is patterned by photolithography using a photoresist pattern to form the contact holes 185 that penetrate the upper and lower passivation layers 180q and 180p as shown in FIG. 7E.

Then, as shown in FIG. 7F, a plurality of transparent electrodes 192 are formed on the resultant of FIG. 7E. The transparent electrodes 192 are connected to the drain electrode 175 through the contact holes 185. Subsequently, a plurality of reflective electrodes 194 made of Ag or Al are formed on the transparent electrodes 192.

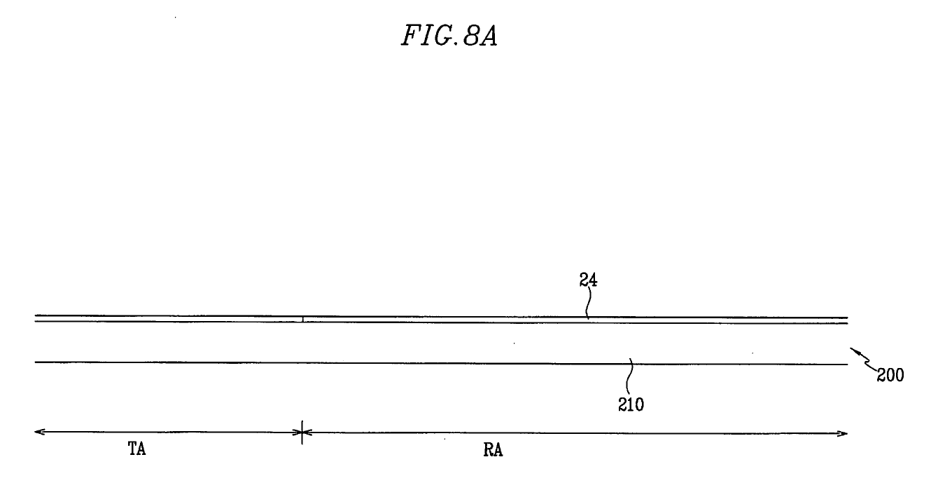

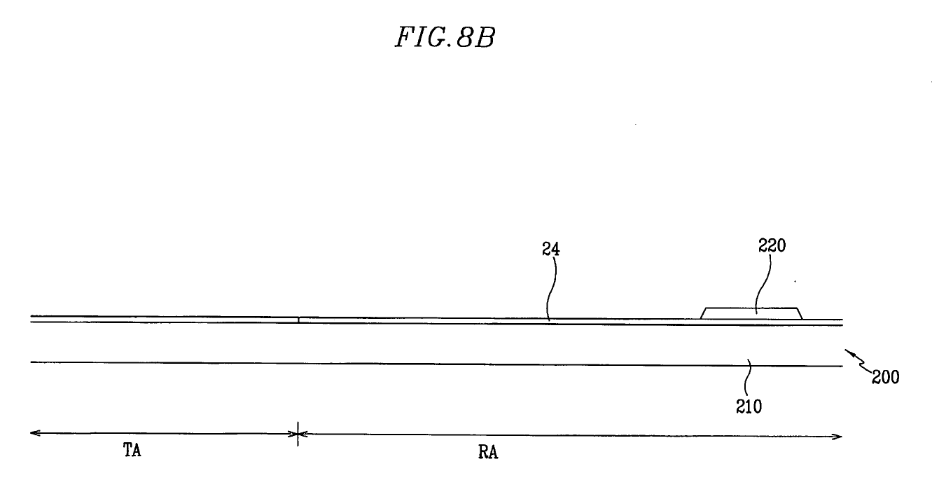

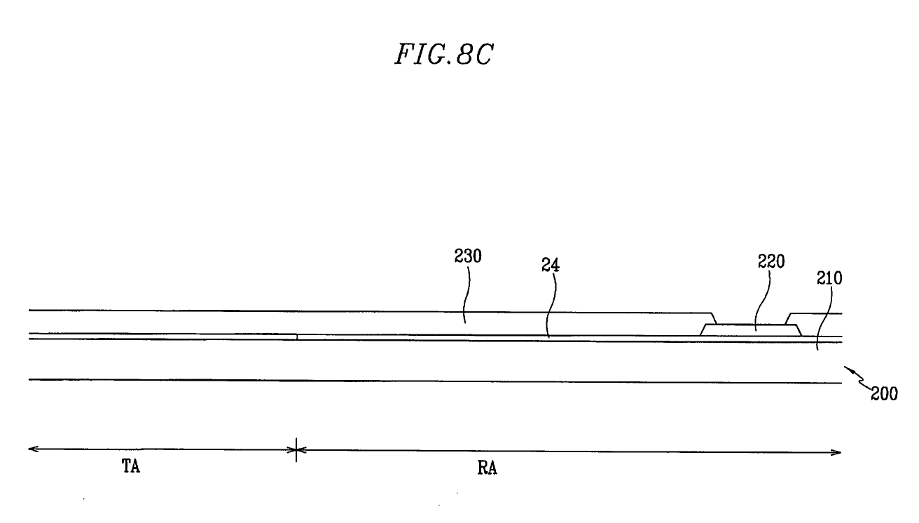

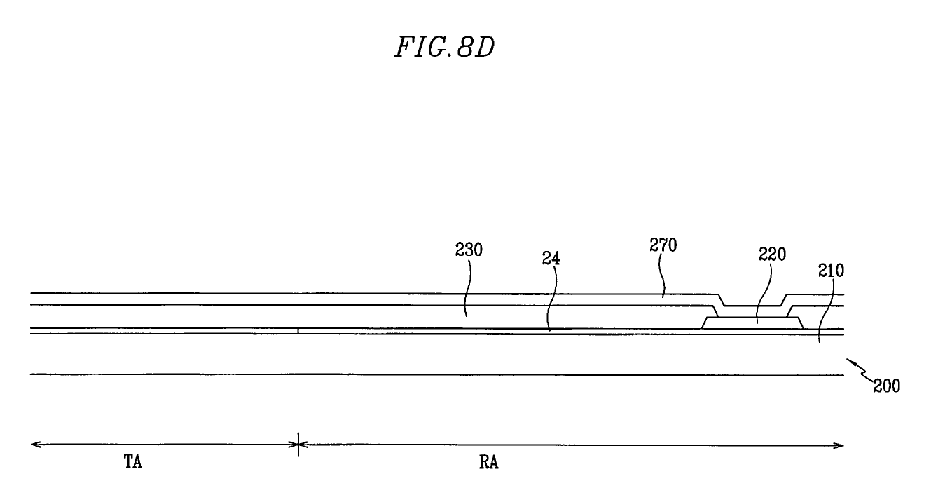

Hereinafter, a method of manufacturing a color filter panel 200 of an LCD according to an another exemplary embodiment of the present invention will be described with reference to FIG. 8A through FIG. 8D.

FIG. 8A through FIG. 8D are schematic cross-sectional views showing an another exemplary method to manufacture a color filter panel 200 of an LCD according to the present invention.

First, an optical retardation layer 24, is formed on an insulating substrate 210, as shown in FIG. 8A. The optical retardation layer 24 does not cause a change in the polarization state of light passing therethrough in the transmission areas TA and does cause a phase difference of a quarter wavelength in the reflection areas RA. The optical retardation layer 24 is produced through successive processes described below. Polyimide is first printed and rubbed on the substrate 210 to form an alignment layer (not shown). In a rubbing process, the reflection areas RA are rubbed at 45 degrees relative to a transmission axis of the polarizer, while the transmission areas TA are rubbed parallel to the transmission axis. Next, an LC polymer or a UV-curable nematic LC monomer is spin-coated on the alignment layer. Then, the substrate 210 is exposed to light, so that an optical retardation layer 24 is formed.

In the next step, a material having a good light-blocking property is deposited on the optical retardation layer 24, and the deposited layer is patterned by photolithography using a mask, thereby forming a light-blocking member 220 as shown in FIG. 8B.

Next, a photosensitive compound is coated on the substrate 210 with the optical retardation layer 24 and the light-blocking member 220, thereby forming a plurality of triplets of color filters 230 as shown in FIG. 8C.

In each color filter 230, a portion corresponding to the transmission area TA may be formed thicker than the remaining portion corresponding to the reflection area RA. These color filters 230 are produced as follows. Photoresist with pigments is first coated on the substrate 210, and then the substrate 210 is pre-baked to remove solvent existing in the photoresist film. Next, the photoresist film is selectively exposed to light, thereby differentiating the curing degree between exposed portions and unexposed portions. Then, a developing process is performed. With the developing process, the color filters 230 are completed.

Also, light holes may be formed at the reflection areas RA of the color filters 230. In this case, the light holes are filled with a transparent organic material.

Meanwhile, the color filters 230 may be formed prior to the formation of optical retardation layer 24. In this case, the color filters 230 are formed with a different thickness in accordance with exhibiting colors, and thus the thickness of the optical retardation layer 24 overlying such color filters 230 becomes different depending on the position. In this structure, the optical retardation layer 24 has a phase difference of a quarter wavelength for a center wavelength of the respective color filters 230. As a result, light passing through each color filter 230 has a phase difference of a quarter wavelength.

Subsequently, as shown in FIG. 8D, a common electrode 270 is formed on the substrate 210 having the color filters 230.

According to the present invention, as mentioned above, the light that enters the reflection areas of the LCD from the backlight unit is introduced to the transmission areas by an internal reflection system of the LCD without absorptive light loss. Such a light is then used to display images, and thus utilization efficiency of light in the LCD is improved.

What is claimed is:

1. A liquid crystal display having a transmission area and a reflection area, comprising:
a first substrate;
a reflection element formed on the first substrate corresponding to the reflection area;
a thin film transistor formed on the first substrate;
a pixel electrode having a transparent electrode that is formed on the thin film transistor and a reflective electrode that overlies the transparent electrode and is formed at the reflection area;
a second substrate;
an optical retardation layer that is formed on the second substrate, the optical retardation layer causes a phase difference between light passing through the transmission area and the reflection area; and
a common electrode formed on the optical retardation layer.

2. The liquid crystal display of claim 1, further comprising a storage electrode that overlaps the pixel electrode.

3. The liquid crystal display of claim 2, wherein the reflection element is adjacent to the storage electrode.

4. The liquid crystal display of claim 2, wherein the reflection element is connected to the storage electrode.

5. The liquid crystal display of claim 1, wherein the thin film transistor includes a gate electrode, a semiconductor formed on the gate electrode, and a source electrode and a drain electrode that are connected to the semiconductor, and the reflection element is connected to the drain electrode.

6. The liquid crystal display of claim 3, wherein at least one outline portion defining the reflection element is placed near a boundary of the reflection area and the transmission area.

7. The liquid crystal display of claim 3, wherein the storage electrode and the reflection element include aluminum (Al), an Al alloy, silver (Ag) or an Ag alloy.

8. The liquid crystal display of claim 1, further comprising a reflection assistant that is formed between the first substrate and the thin film transistor, the reflection assistant is placed at the reflection area.

9. The liquid crystal display of claim 8, wherein the reflection assistant includes a dielectric with a multi-layered structure.

10. The liquid crystal display of claim 9, wherein each layer in the multi-layered structure has a thickness satisfying nd=λ/4, where n is a refractive index of the layer, d is a thickness of the layer and λ is a wavelength of light.

11. The liquid crystal display of claim 10, wherein the dielectric includes at least a low refractive layer and a high refractive layer.

12. The liquid crystal display of claim 11, wherein the high refractive layer includes ZrO, TiO₂ or ZnS, while the low refractive layer includes MgF₂ or CeF₂.

13. The liquid crystal display of claim 1, wherein the optical retardation layer causes a phase difference of a quarter wavelength in light passing therethough in the reflection area, while causing no phase difference in the transmission area.

14. The liquid crystal display of claim 1, wherein the optical retardation layer includes a liquid crystal polymer.

15. The liquid crystal display of claim 14, wherein the liquid crystal polymer is obtained by curing a UV-curable nematic liquid crystal monomer.

16. The liquid crystal display of claim 1, further comprising a backlight unit that is disposed at the rear of the first substrate.

17. The liquid crystal display of claim 16, wherein the backlight
unit includes a reflective plate.

18. The liquid crystal display of claim 1, wherein the liquid crystal layer includes liquid crystal molecules that are aligned in a twisted nematic mode.

19. The liquid crystal display of claim 1, further comprising a passivation layer formed between the thin film transistor and the transparent electrode, and the passivation layer having an opening that is placed at the transmission area.

20. The liquid crystal display of claim 1, further comprising color filters formed between the optical retardation layer and the common electrode.

21. The liquid crystal display of claim 1, further comprising color filters formed between the second substrate and the optical retardation layer.

22. The liquid crystal display of claim 21, wherein the color filters exhibit different colors with each other and have different thicknesses depending on the exhibiting colors.

23. The liquid crystal display of claim 21, wherein a portion of each color filter corresponding to the transmission area is formed thicker than the remaining portion of the same color filter corresponding to the reflection area.

24. The liquid crystal display of claim 20, wherein the color filters exhibit different colors with each other and have different thicknesses depending on the exhibiting colors.

25. The liquid crystal display of claim 20, wherein a portion of each color filter corresponding to the transmission area is formed thicker than the remaining portion of the same color filter corresponding to the reflection area.

26. The liquid crystal display of claim 1, further comprising a first polarizer and a second polarizer that are individually attached to outer surfaces of the first substrate and the second substrate, respectively.

27. A method of manufacturing a TFT array panel of an LCD, the method comprising:
alternately depositing two media having different indices of refraction on an insulating substrate forming a dielectric layer consisting of first and second alternating layers;
removing the dielectric layer corresponding to transmission areas TA forming a plurality of reflection assistants existing only at reflective areas RA;
forming a first conductive layer on the substrate having the reflection assistants;
selectively etching the first conductive layer forming a plurality of gate lines with gate electrodes, a plurality of storage electrode lines with storage electrodes and a plurality of reflection assistants;
depositing in succession a gate insulating layer, a hydrogenated amorphous silicon layer, and an amorphous silicon layer doped with N+ impurities on the first conductive layer;
patterning the hydrogenated amorphous silicon layer and the doped amorphous silicon layer forming a plurality of semiconductors with a plurality of projections and expansions, and forming a plurality of ohmic contact patterns;
forming a second conductive layer made of a refractory metal including one of a Mo-containing metal, Ta, Cr or Ti, on a resultant of the patterning;
selectively etching the second conductive layer forming a plurality of data lines with source electrodes and end portions, and a plurality of drain electrodes with expansions;
removing exposed portions of the ohmic contact patterns, which are not covered with the data lines and the drain electrodes, thereby forming a plurality of ohmic contacts, and the underlying semiconductors are exposed between the ohmic contacts;
performing an O₂ plasma to stabilize the exposed surfaces of the semiconductors;
depositing a lower passivation layer consisting of SiNx is deposited on the entire substrate;
forming an upper passivation layer on the lower passivation layer;
partially exposing the upper passivation layer to light through a mask, and then a developing process is performed, thereby forming a plurality of contact holes through which the lower passivation layer overlying the expansions of the drain electrodes is partially exposed;
forming an uneven at a surface of the upper passivation layer;
removing the upper passivation layer corresponding to the transmission areas TA forming a plurality of transmission windows;
patterning the lower passivation layer by photolithography using a photoresist pattern to form the contact holes that penetrate the upper and lower passivation layers;
forming a plurality of transparent electrodes connected to the drain electrode through the contact holes; and
forming a plurality of reflective electrodes made of Ag or Al on the transparent electrodes.

28. The method claim 27, wherein the depositing the dielectric layer is by a sputtering process.

29. The method claim 27, wherein the removing the dielectric layer is removed by photolithography.

30. The method claim 27, wherein the forming the first and second conductive layers is by a sputtering process.

31. The method claim 27, wherein the conductive layer may be made of an Al-containing metal such as Al or an Al alloy, a Ag-containing metal such as Ag or a Ag alloy, a Cu-containing metal such as Cu or a Cu alloy, a Mo-containing metal such as Mo or a Mo alloy, Cr, Ti or To.

32. The method claim 27, wherein the etching is by photolithography.

33. The method claim 27, wherein the reflection assistant is one of integrally formed with the storage electrode line separated from the storage electrode lines,

34. The method claim 27, wherein the depositing in succession is by one of low pressure chemical vapor deposition (“LPCVD”) and plasma enhanced chemical vapor deposition (“PECVD”).

35. The method claim 27, wherein the gate insulating layer is made of SiNx.

36. The method claim 27, further comprising:
forming a plurality of reflection assistants in the reflection area RA up to a boundary of the reflection area RA and the transmission area TA.

37. The method claim 27, wherein the lower passivation layer consists of SiNx and the upper passivation layer consists of an organic material.
